(19) United States
(12) Patent Application Publication
(10) Pub. No.: US 2014/0191017 A1
(43) Pub. Date: Jul. 10, 2014

(54) NICKEL-BASED ALLOY, USE AND METHOD

(71) Applicants: Nikolai Arjakine, Berlin (DE); Torsten Jokisch, Neuenhagen bei Berlin (DE); Andreas Neidel, Berlin (DE); Michael Ott, Mulheim an der Ruhr (DE); Sebastian Piegert, Berlin (DE); Dimitrios Thomaidis, Berlin (DE)

(72) Inventors: Nikolai Arjakine, Berlin (DE); Torsten Jokisch, Neuenhagen bei Berlin (DE); Andreas Neidel, Berlin (DE); Michael Ott, Mulheim an der Ruhr (DE); Sebastian Piegert, Berlin (DE); Dimitrios Thomaidis, Berlin (DE)

(73) Assignee: SIEMENS AKTIENGESELLSCHAFT, München (DE)

(21) Appl. No.: 14/131,105

(22) PCT Filed: Jun. 13, 2012
(86) PCT No.: PCT/EP2012/061167

§ 371 Date: Mar. 13, 2014

(30) Foreign Application Priority Data
Jul. 12, 2011 (EP) 11173590.8

(51) Int. Cl. B23K 35/30; B23P 6/00

(52) U.S. Cl. CPC B23K 35/304; B23P 6/007
USPC 228/119; 420/448; 420/449

(57) ABSTRACT

The invention relates to a novel alloy which comprises the elements carbon (C), chromium (Cr), cobalt (Co), molybdenum (Mo), tungsten (W), titanium (Ti), aluminium (Al), boron (B), and zirconium (Zr), based on nickel, and which has a very low tendency to form cracks during welding.

The invention relates to a nickel-based superalloy which can be used, in particular, for welding.

Nickel-based materials are known in particular from turbine blades or vanes of gas turbines and have high strengths at high temperatures. Similarly, nickel-based superalloys have to have a low sensitivity to cracking, i.e. a high ductility. U.S. Pat. No. 3,615,376 discloses Rene 80.

The same property is also required of alloys which are used to weld nickel-based superalloys. Cracks often form in the welded region, but this should be avoided.

It is therefore an object of the invention to solve the aforementioned problem.

The object is achieved by an alloy as claimed in claim 1, the use as claimed in claim 9 and a process as claimed in claim 11.

The dependent claims list further advantageous measures which can be combined with one another, as desired, in order to achieve further advantages.

The alloy has good properties at high temperatures. Similarly, it can be used as a welding alloy, in which case the possibilities for components made of Rene 80 to be repaired are improved, the reject rate is reduced, the welding quality is improved particularly in the case of manual welding and unit costs are reduced even in the case of an automated process. In the case of laser cladding processes, it is advantageously used for materials to be welded which are sensitive to hot cracking.

Moreover, no preheating or overaging of components, which is often carried out during welding, is required, and therefore here too there is a reduction in costs, because no outlay on apparatus is needed and no time is required for heat treatment.

This is possible since the small proportions of grain boundary strengthener in this alloy as the welding material or as the substrate reduce the risk of cracking during heating and cooling for and during the welding, as a result of which the weldability is increased.

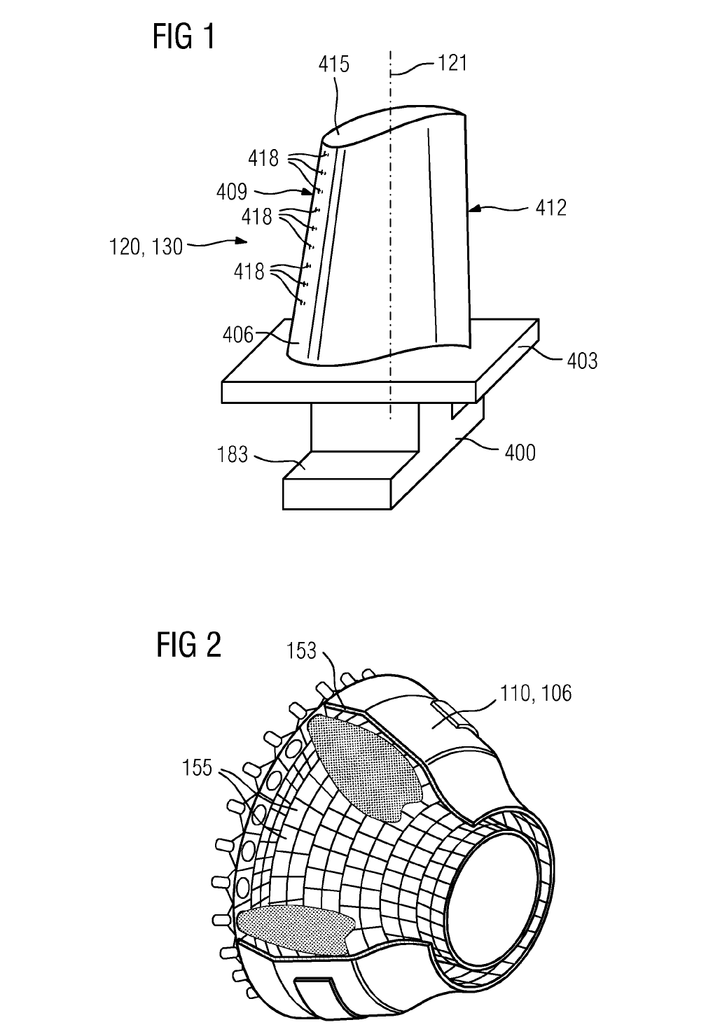

FIG. 1 shows a turbine blade or vane,

FIG. 2 shows a combustion chamber,

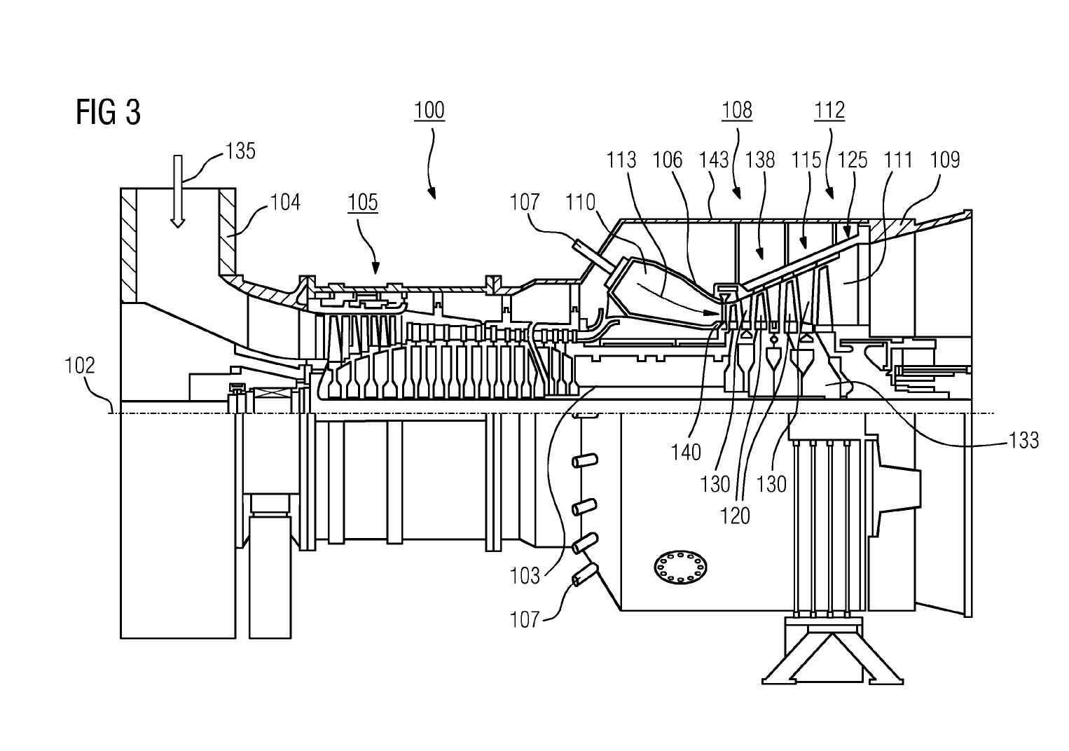

FIG. 3 shows a gas turbine,

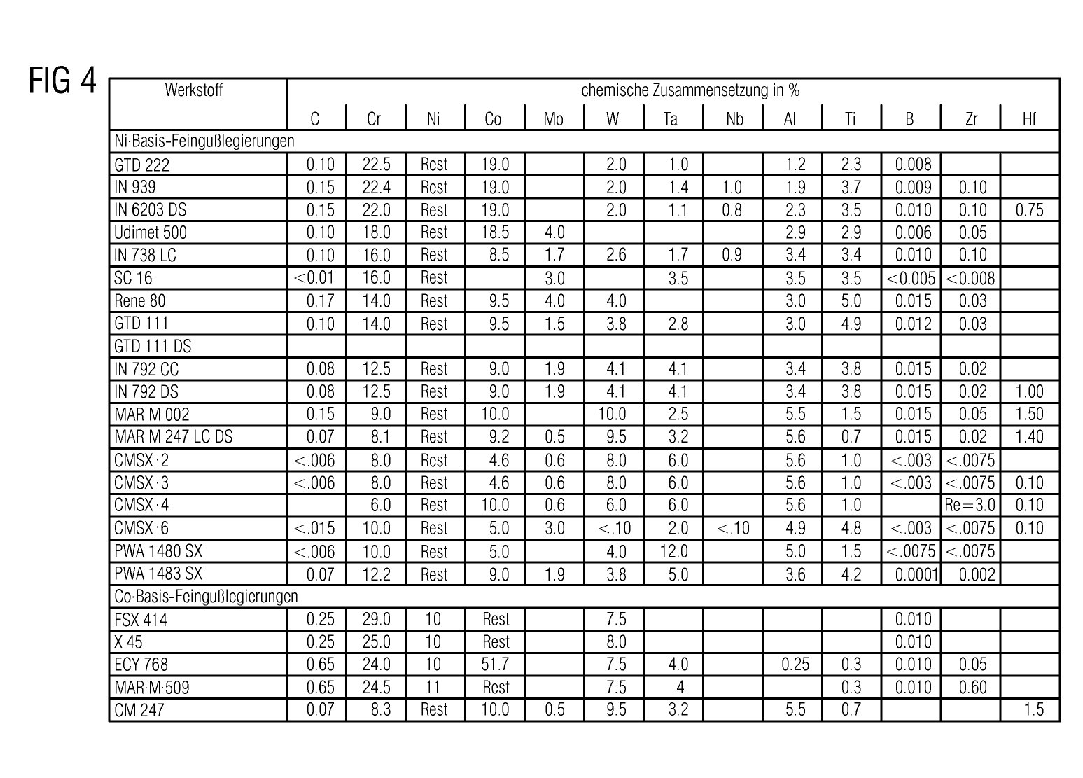

FIG. 4 shows a list of superalloys.

The figures and the description represent only exemplary embodiments of the invention.

The nickel-based alloy comprises at least (in % by weight):

carbon (C) 0.13%-0.2%,

chromium (Cr) 13.5%-14.5%,

cobalt (Co) 9.0%-10.0%,

molybdenum (Mo) 1.5%-2.4%,

tungsten (W) 3.4%-4.0%,

titanium (Ti) 4.6%-5.0%,

aluminum (Al) 2.6%-3.0%,

boron (B) 0.005%-0.008%,

in particular remainder nickel (Ni),

optionally

niobium (Nb) max. 0.1%,

tantalum (Ta) max. 0.1%,

zirconium (Zr) max. 0.05%,

in particular at least 0.02%,

hafnium (Hf) max. 0.1%,

silicon (Si) max. 0.1%

manganese (Mn) max. 0.1%

and impurities,

in particular phosphorus (P), iron (Fe), sulfur (S), vanadium (V), copper (Cu), lead (Pb), bismuth (Bi), selenium (Se), tellurium (Te), thallium (Tl), magnesium (Mg), nitrogen (N), silver (Ag).

The indication “max” denotes that the alloying element is usually present in the alloy and is tolerated up to the maximum value.

Impurity means that the proportion of the alloying element(s) is to be minimized.

It is advantageously possible to dispense with additives such as tantalum (Ta), silicon (Si), niobium (Nb), hafnium (Hf), manganese (Mn) and/or rhenium (Re).

Other melting-point reducers are preferably dispensed with; these are also gallium (Ga) and/or germanium (Ge).

The small proportions of boron and molybdenum mean that fewer borides or carbides and sulfides form, these forming low-melting phases on the grain boundaries which would otherwise promote crack formation. The welding process, in particular the powder welding process, can thus be carried out at room temperature.

The alloy can be used as substrate material for high-temperature components such as turbine components.

Similarly, the alloy can be used as a welding alloy for substrates, in particular consisting of Rene 80 or other nickel-based superalloys, very particularly for alloys as shown in FIG. 4.

FIG. 1 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415. As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949.

The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses. Single-crystal workpieces of this type are produced, for example, by directional solidification from the melt. This involves casting processes in which the liquid metallic alloy solidifies to form the single-crystal structure, i.e. the single-crystal workpiece, or solidifies directionally. In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures). Processes of this type are known from U.S. Pat. No. 6,024,792 and EP 0 892 090 A1.

The blades or vanes 120, 130 may likewise have coatings protecting against corrosion or oxidation e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1.

The density is preferably 95% of the theoretical density.

A protective aluminum oxide layer (TGO=thermally grown oxide layer) is formed on the MCrAlX layer (as an intermediate layer or as the outermost layer).

The layer preferably has a composition Co-30Ni-28Cr-8Al-0.6Y-0.7Si or Co-28Ni-24Cr-10Al-0.6Y. In addition to these cobalt-based protective coatings, it is also preferable to use nickel-based protective layers, such as Ni-10Cr-12Al-0.6Y-3Re or Ni- 12Co-21Cr-11Al-0.4Y-2Re or Ni-25Co-17Cr-10Al-0.4Y-1.5Re.

It is also possible for a thermal barrier coating, which is preferably the outermost layer and consists for example of ZrO₂, Y₂O₃-ZrO₂, i.e. unstabilized, partially stabilized or fully stabilized by yttrium oxide and/or calcium oxide and/or magnesium oxide, to be present on the MCrAlX.

The thermal barrier coating covers the entire MCrAlX layer. Columnar grains are produced in the thermal barrier coating by suitable coating processes, such as for example electron beam physical vapor deposition (EB-PVD).

Other coating processes are possible, for example atmospheric plasma spraying (APS), LPPS, VPS or CVD. The thermal barrier coating may include grains that are porous or have micro-cracks or macro-cracks, in order to improve the resistance to thermal shocks. The thermal barrier coating is therefore preferably more porous than the MCrAlX layer.

Refurbishment means that after they have been used, protective layers may have to be removed from components 120, 130 (e.g. by sand-blasting). Then, the corrosion and/or oxidation layers and products are removed. If appropriate, cracks in the component 120, 130 are also repaired. This is followed by recoating of the component 120, 130, after which the component 120, 130 can be reused.

The blade or vane 120, 130 may be hollow or solid in form. If the blade or vane 120, 130 is to be cooled, it is hollow and may also have film-cooling holes 418 (indicated by dashed lines).

FIG. 2 shows a combustion chamber 110 of a gas turbine. The combustion chamber 110 is configured, for example, as what is known as an annular combustion chamber, in which a multiplicity of burners 107, which generate flames 156, arranged circumferentially around an axis of rotation 102 open out into a common combustion chamber space 154. For this purpose, the combustion chamber 110 overall is of annular configuration positioned around the axis of rotation 102.

To achieve a relatively high efficiency, the combustion chamber 110 is designed for a relatively high temperature of the working medium M of approximately 1000° C. to 1600° C. To allow a relatively long service life even with these operating parameters, which are unfavorable for the materials, the combustion chamber wall 153 is provided, on its side which faces the working medium M, with an inner lining formed from heat shield elements 155.

On the working medium side, each heat shield element 155 made from an alloy is equipped with a particularly heat-resistant protective layer (MCrAlX layer and/or ceramic coating) or is made from material that is able to withstand high temperatures (solid ceramic bricks).

These protective layers may be similar to the turbine blades or vanes, i.e. for example MCrAlX: M is at least one element selected from the group consisting of iron (Fe), cobalt (Co), nickel (Ni), X is an active element and stands for yttrium (Y) and/or silicon and/or at least one rare earth element or hafnium (Hf). Alloys of this type are known from EP 0 486 489 B1, EP 0 786 017 1, EP 0 412 397 B1 or EP 1 306 454 A1.

It is also possible for a, for example, ceramic thermal barrier coating to be present on the MCrAlX, consisting for example of ZrO₂, Y₂O₃-ZrO₂, i.e. unstabilized, partially stabilized or fully stabilized by yttrium oxide and/or calcium oxide and/or magnesium oxide.

Columnar grains are produced in the thermal barrier coating by suitable coating processes, such as for example electron beam physical vapor deposition (EB-PVD).

Other coating processes are possible, e.g. atmospheric plasma spraying (APS), LPPS, VPS or CVD. The thermal barrier coating may include grains that are porous or have micro-cracks or macro-cracks, in order to improve the resistance to thermal shocks.

Refurbishment means that after they have been used, protective layers may have to be removed from heat shield elements 155 (e.g. by sand-blasting). Then, the corrosion and/or oxidation layers and products are removed. If appropriate, cracks in the heat shield element 155 are also repaired. This is followed by recoating of the heat shield elements 155, after which the heat shield elements 155 can be reused.

Moreover, a cooling system may be provided for the heat shield elements 155 and/or their holding elements, on account of the high temperatures in the interior of the combustion chamber 110. The heat shield elements 155 are then, for example, hollow and may also have cooling holes (not shown) opening out into the combustion chamber space 154.

1. A nickel-based alloy
which at least comprises (in % by weight):
carbon (C) 0.13%-0.2%,
chromium (Cr) 13.5%-14.5%,
cobalt (Co) 9.0%-10.0%,
molybdenum (Mo) 1.5%-2.4%,
tungsten (W) 3.4%-4.0%,
titanium (Ti) 4.6%-5.0%,
aluminum (Al) 2.6%-3.0%,
boron (B) 0.005%-0.008%,
with a remainder of nickel (Ni),
optionally
niobium (Nb) max. 0.1%,
tantalum (Ta) max. 0.1%,
zirconium (Zr) max. 0.05% and at least 0.02%,
hafnium (Hf) max. 0.1%,
silicon (Si) max. 0.1%,
manganese (Mn) max. 0.1%
and impurities,
comprising phosphorus (P), iron (Fe), sulfur (S), vanadium (V), copper (Cu), lead (Pb), bismuth (Bi), selenium (Se), tellurium (Te), thallium (Tl), magnesium (Mg), nitrogen (N), silver (Ag), and comprises these alloying elements.

2. The nickel-based alloy as claimed in claim 1, which at least comprises (values in % by weight, in particular ±5%): 0.15% carbon (C), 4.3% chromium (Cr), 9.5% cobalt (Co),
1.7% molybdenum (Mo),
3.7% tungsten (W),
4.8% titanium (Ti),
2.8% aluminum (Al),
0.0075% boron (B),
optionally 0.025% zirconium (Zr),
and remainder nickel (Ni).

3. The alloy as claimed in claim 1, which comprises no niobium (Nb).

4. The alloy as claimed in claim 1, which comprises no tantalum (Ta).

5. The alloy as claimed claim 1, which comprises no silicon (Si) or no gallium (Ga) or no germanium (Ge).

6. The alloy as claimed in claim 1, which comprises no hafnium (Hf).

7. The alloy as claimed in claim 1, which comprises no manganese (Mn).

8. The alloy as claimed in claim 1, which comprises no rhenium (Re).

9. A welding alloy for nickel-based or cobalt-based alloys comprised of the alloy of claim 1.

10. A filler material for welding Rene 80 comprised of the alloy of claim 9.

11. A process for repairing a component, comprising welding a nickel-based or cobalt-based substrate using an alloy as claimed in claim 1 as a filler material.

12. The process as claimed in claim 11, further comprising not overaging the component before the welding.

13. The process as claimed in claim 11, further comprising not preheating the component during the welding.

14. The process as claimed in claim 11, further comprising carrying out powder build-up welding.

15. The process as claimed in claim 11, further comprising carrying out the process at room temperature.

16. The process as claimed in claim 11, in which Rene 80 is welded.
